(19) United States
(12) Patent Application Publication
(10) Pub. No.: US 2016/0044258 A1
(43) Pub. Date: Feb. 11, 2016

(54) IMAGING APPARATUS AND IMAGING METHOD THEREOF

(71) Applicant: SAMSUNG ELECTRONICS CO., LTD., Suwon-si (KR)

(72) Inventors: Il-do KIM, Suwon-si (KR); Jeong-won LEE, Seongnam-si (KR)

(73) Assignee: SAMSUNG ELECTRONICS CO., LTD., Suwon-si (KR)

(21) Appl. No.: 14/817,870

(22) Filed: Aug. 4, 2015

(30) Foreign Application Priority Data
Aug. 11, 2014 (KR) 10-2014-0103533

(51) Int. Cl. H04N 5/355; H04N 5/235

(52) U.S. Cl. CPC H04N 5/35581; H04N 5/2355; H04N 5/2353; H04N 5/3559

(57) ABSTRACT

An imaging apparatus and an image method thereof are provided. The imaging apparatus includes an image pickup including a pixel, the pixel being configured to accumulate a charge. The imaging apparatus further includes an image processor configured to perform image processing based on the accumulated charge to generate an image, a signal generator, and a controller configured to determine an exposure pattern of the pixel, and control the signal generator to generate a reset signal based on the determined exposure pattern. The pixel is configured to accumulate the charge based on the reset signal.

### CROSS-REFERENCE TO RELATED APPLICATION

This application claims priority from Korean Patent Application No. 10-2014-0103533, filed on Aug. 11, 2014, in the Korean Intellectual Property Office, the disclosure of which is incorporated herein by reference in its entirety.

### BACKGROUND

1. Field

Apparatuses and methods consistent with exemplary embodiments relate to an imaging apparatus and an imaging method thereof.

2. Description of the Related Art

A global shutter type imaging apparatus in the related art may include two charge storage regions. Accordingly, a plurality of pixel regions that constitute an image pickup unit of the imaging apparatus may twice perform exposure with different exposure times. At a time when the first exposure ends, the imaging apparatus may store charge that is accumulated in the respective pixel regions in a first charge storage region, and at a time when the second exposure starts, the imaging apparatus may store the charge that is stored in the first charge storage region in a second storage region. Thereafter, the imaging apparatus may read out all the charge that is stored in the second charge storage region, and may store the charge that is generated by performing the second exposure in the respective pixel regions in the second charge storage region. Accordingly, the imaging apparatus can acquire an image having a high dynamic range (HDR) through combination of a first output value that is read out in relation to the first exposure and a second output value that is read out in relation to the second exposure.

Another global shutter type imaging apparatus in the related art may set different exposure times in the plurality of pixel regions in relation to an image to be captured. That is, the imaging apparatus may capture an image by performing long exposure type exposure in at least one pixel region and performing short exposure type exposure in remaining pixel regions, among the plurality of pixel regions in relation to the image to be captured, and may acquire an image having the HDR by compensating for the captured image.

The HDR image as described above may be implemented by the following image processing methods.

The first image processing method is a method to process one sheet of an image that is captured through single exposure, and may include gamma correction or retinex image enhancement. This image processing method may have problems in that noise may be increased in the image process, and it may be difficult to express detailed grayscales.

The second image processing method is a method to acquire two images having different exposure amounts by arranging pixels having different sensitivities in one pixel region through an image pickup unit, and then to obtain an HDR image by synthesizing and compensating for the data. However, according to this image processing method, because the image pickup unit operates with fixed sensitivity, two same images may be generated, and thus expansion of the dynamic range may be limited.

The third image processing method is a method to acquire images having different exposure times with respect to a plurality of pixel regions that constitute an image sensor by controlling a signal of an image pickup unit, and then to obtain an HDR image by compensating for the data. However, according to this image processing method, because different exposure start and exposure end times are set with respect to the respective pixel regions to make different exposure times for the plurality of pixel regions, a motion artifact may occur on a moving object.

The fourth image processing method is a method to acquire a plurality of images having different exposure amounts from a plurality of pixel regions that constitute an image pickup unit, and to obtain an HDR image by synthesizing the acquired images. However, according to this image processing method, because a plurality of exposure operations is needed, a large amount of time may be consumed in acquiring the image. Further, if hand trembling occurs or an object is moving while a plurality of exposure operations are performed, a motion artifact may occur in the process of synthesizing the HDR images.

### SUMMARY

Exemplary embodiments address at least the above disadvantages and other disadvantages not described above. Also, exemplary embodiments are not required to overcome the disadvantages described above, and may not overcome any of the problems described above.

Exemplary embodiments provide an imaging apparatus and an imaging method thereof, which can acquire time division multiple exposure images using a global shutter system.

According to an aspect of an exemplary embodiment, there is provided an imaging apparatus including an image pickup including a pixel, the pixel being configured to accumulate a charge. The imaging apparatus further includes an image processor configured to perform image processing based on the accumulated charge to generate an image, a signal generator, and a controller configured to determine an exposure pattern of the pixel, and control the signal generator to generate a reset signal based on the determined exposure pattern. The pixel is configured to accumulate the charge based on the reset signal.

The pixel may include a light receiver, a temporary storage configured to temporarily store the charge that is accumulated in the light receiver, a charge storage configured to store the charge temporarily stored in the temporary storage, a charge transferer configured to transfer the charge stored in the charge storage to the image processor, a first switch configured to turn on to temporarily store in the temporary storage the charge accumulated in the light receiver after the signal generator generates and applies to the pixel signal an initial reset signal, a second switch configured to turn on to store in the charge storage the charge temporarily stored in the temporary storage, and a third switch configured to turn on to transfer the charge stored in the charge storage to the charge transferer.

The exposure pattern may include an exposure time duration and a non-exposure time duration. The exposure time duration may be a time duration in which the charge is accumulated in the light receiver after the signal generator applies the initial reset signal to the pixel, and the first switch is turned on to temporarily store in the temporary storage the charge accumulated in the light receiver. The non-exposure time duration may be a time duration in which the signal generator applies the reset signal to the pixel to suspend the charge from accumulating in the light receiver after the first switch is turned on.

The controller may be further configured to determine exposure patterns of pixels that constitute the image.

The controller may be configured to apply a first exposure pattern to first pixels having a first brightness, among the pixels, and apply a second exposure pattern to second pixels having a second brightness, among the pixels, based on brightness information of the pixels.

The controller may be configured to apply an exposure pattern of a short exposure type to pixels that are bright, among the pixels, and apply an exposure pattern of a long exposure type to pixels that are dark, among the pixels, based on the brightness information.

The controller may be configured to apply an exposure pattern of a long exposure type to outer pixels, among the pixels, and apply an exposure pattern of a short exposure type to center pixels, among the pixels, based on lens characteristics.

The controller may be configured to differently apply the exposure patterns to respective objects included in the image.

The imaging apparatus may further include a motion sensor configured to sense motion of the imaging apparatus, and the controller may be configured to apply, to at least one of the pixels, an exposure pattern to perform exposure in a time duration in which the sensed motion belongs to a range.

The imaging apparatus may further include a storage configured to store the exposure patterns, and the controller may be configured to apply the stored exposure patterns to the pixels based on brightness information of the pixels.

The image pickup may be a global shutter type image sensor.

According to an aspect of another exemplary embodiment, there is provided an imaging method of an imaging apparatus including determining an exposure pattern of a pixel, generating a reset signal based on the determined exposure pattern, accumulating charge in the pixel based on the reset signal, and performing image processing based on the accumulated charge to generate an image.

The accumulating may include temporarily storing in a temporary storage the charge that is accumulated in a light receiver by turning on a first switch after generating and applying to the pixel an initial reset signal, storing in a charge storage the charge temporarily stored in the temporary storage by turning on a second switch, and transferring the charge stored in the charge storage to an image processor that performs the image processing by turning on a third switch.

The imaging method may further include determining exposure patterns of pixels that constitute the image.

The determining the exposure patterns may include applying a first exposure pattern to first pixels having a first brightness, among the pixels, and applying a second exposure pattern to second pixels having a second brightness, among the pixels, based on brightness information of the pixels.

The determining the exposure patterns may include applying an exposure pattern of a short exposure type to pixels that are bright, among the pixels, and applying an exposure pattern of a long exposure type to pixels that are dark among the pixels, based on the brightness information.

The determining the exposure patterns may include applying an exposure pattern of a long exposure type to outer pixels, among the pixels, and applying an exposure pattern of a short exposure type to center pixels, among the pixels, based on lens characteristics.

The determining the exposure patterns may include differently applying the exposure patterns to respective objects included in the image.

The imaging method may further include sensing motion of the imaging apparatus, and the determining the exposure patterns may include applying, to at least one of the pixels, an exposure pattern to perform exposure in a time duration in which the sensed motion belongs to a range.

The imaging method may further include storing the exposure patterns, and the determining the exposure patterns may include applying the stored exposure patterns to the pixels based on brightness information of the pixels.

The pixels may be included in a global shutter type image sensor.

According to an aspect of an exemplary embodiment, there is provided an imaging apparatus including an image pickup including pixels, a controller configured to control a light exposure of the pixels based on at least one among brightness information of the pixels, lens information of the pixels, and motion of the imaging apparatus. The imaging apparatus further includes an image processor configured to perform image processing based on a charge that is accumulated in each of the pixels to generate an image.

The controller may be configured to apply a long light exposure to dark pixels, among the pixels, and apply a short light exposure to bright pixels, among the pixels.

The controller may be configured to apply a long light exposure to outer pixels corresponding to an outer region of a lens of the imaging apparatus, among the pixels, and apply a short light exposure to center pixels corresponding to a center region of the lens, among the pixels.

The controller may be configured to apply, to at least one of the pixels, a light exposure of a time duration in which the motion is in a range.

### BRIEF DESCRIPTION OF THE DRAWINGS

The above and/or other aspects will be more apparent by describing in detail exemplary embodiments with reference to the accompanying drawings, in which:

FIG. 1 is a block diagram of an imaging apparatus according to an exemplary embodiment;

FIG. 2 is a detailed block diagram of a pixel of an image pickup of the imaging apparatus of FIG. 1;

FIG. 3 is a detailed block diagram of the imaging apparatus of FIG. 1;

FIG. 4 is a diagram illustrating a structure of an image pickup according to an exemplary embodiment;

FIG. 5 is a timing diagram illustrating short exposure type exposure patterns applied to a plurality of pixel regions that constitute an image pickup in accordance with a reset signal for each of the regions according to an exemplary embodiment;

FIG. 6 is a timing diagram illustrating middle exposure type exposure patterns applied to a plurality of pixel regions that constitute an image pickup in accordance with a reset signal for each of the regions according to an exemplary embodiment;

FIG. 7 is a timing diagram illustrating long exposure type exposure patterns applied to a plurality of pixel regions that constitute an image pickup in accordance with a reset signal for each of the regions according to an exemplary embodiment;

FIGS. 8A and 8B are first diagrams illustrating performing of an exposure control of a plurality of pixel regions that constitute an image pickup in accordance with exposure patterns according to an exemplary embodiment;

FIGS. 9A and 9B are second diagrams illustrating performing of an exposure control of a plurality of pixel regions that constitute an image pickup in accordance with exposure patterns according to another exemplary embodiment;

FIG. 10 is a third diagram illustrating performing of an exposure control of a light receiver in accordance with exposure patterns according to an exemplary embodiment;

FIG. 11 is a fourth diagram illustrating performing of an exposure control of a light receiver in accordance with exposure patterns according to another exemplary embodiment;

FIG. 12 is a fifth diagram illustrating performing of an exposure control of a light receiver in accordance with exposure patterns according to still another exemplary embodiment;

FIG. 13 is a diagram illustrating a multi-exposure image in accordance with an exposure control of a plurality of pixel regions that constitute an image pickup in accordance with exposure patterns according to an exemplary embodiment; and

FIG. 14 is a flowchart of an imaging method of an imaging apparatus according to an exemplary embodiment.

### DETAILED DESCRIPTION OF THE EXEMPLARY EMBODIMENTS

Hereinafter, exemplary embodiments are described in more detail with reference to the accompanying drawings.

In the following description, like reference numerals are used for like elements even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail because they would obscure the exemplary embodiments with unnecessary detail.

It will be understood that the terms such as “unit,” “-er (-or),” and “module” described in the specification refer to an element configured to perform at least one function or operation, and may be implemented in hardware or a combination of hardware and software.

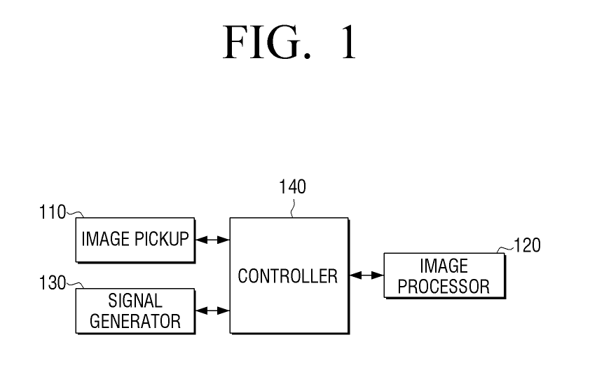

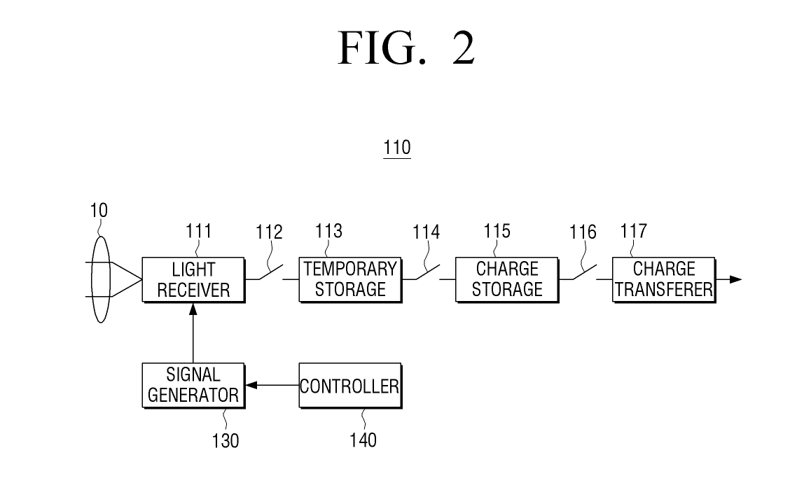

FIG. 1 is a block diagram of an imaging apparatus according to an exemplary embodiment, and FIG. 2 is a detailed block diagram of a pixel of an image pickup 110 of the imaging apparatus of FIG. 1.

As illustrated in FIG. 1, the imaging apparatus includes the image pickup 110, an image processor 120, a signal generator 130, and a controller 140.

The image pickup 110 includes a plurality of pixels, and temporarily stores charge that is accumulated in each of a plurality of pixel regions. Referring to FIG. 2, each of the plurality of pixels includes a light receiver 111 and a temporary storage 113 configured to temporarily store charge that is accumulated in the light receiver 111. The image pickup 110 may include a plurality of temporary storages corresponding to the plurality of pixel regions. Further, the image pickup 110 may be, for example, a global shutter type image sensor, such as a charge-coupled device (CCD) or a CMOS image sensor (CIS), which accumulates the charge that is obtained by converting exposure light that is incident through a lens 10 into an electrical signal.

Referring again to FIG. 1, the image processor 120 receives the accumulated charge from the image pickup 110, and performs image processing based on the accumulated charge to generate an image. In detail, the charge that is accumulated in the image pickup 110 in relation to one image may be amplified to an analog signal having an appropriate size through an automatic gain controller (AGC), and the amplified analog signal may be converted into a digital signal through an analog-to-digital converter (ADC). The image processor 120 may receive the digital signal for the charge that is accumulated in relation to the one image, and perform image processing, such as, for example, correlation and synthesis, on the digital signal to generate an entire image signal for the captured image.

The signal generator 130 generates a reset signal of the light receiver 111. For example, the reset signal may include an initial reset signal and a reset signal for each of the regions. The initial reset signal may be a reset signal for emptying the residual charge accumulated in each of the plurality of pixel regions when the plurality of pixel regions simultaneously start exposure in accordance with a global shutter system. Further, the reset signal for each of the regions may be a reset signal for starting time division multiple exposures in at least one of the plurality of pixel regions after the initial reset signal is applied to the light receiver 111.

Accordingly, when the initial reset signal is received from the signal generator 130, the light receiver 111 empties the residual charge accumulated in each of the plurality of pixel regions. Thereafter, when the reset signal for each of the regions is applied to at least one of the plurality of pixel regions, the at least one of the plurality of pixel regions may start the time division multiple exposure in accordance with the applied reset signal for each of the regions.

The controller 140 determines exposure patterns for one image to be captured, and controls the signal generator 130 to generate a plurality of reset signals in accordance with the determined exposure patterns. Thereafter, the controller 140 controls the image pickup 110 to store the charge accumulated in each of the plurality of pixel regions in a temporary storage 113 of FIG. 2. Further, the controller 140 controls the image processor 120 to receive the accumulated charge from the image pickup 110, and to perform the image processing to generate the image to be captured.

In detail, when an imaging command for one image is input, the controller 140 controls the signal generator 130 to generate the initial reset signal. Accordingly, the signal generator 130 generate the initial reset signal, and the controller 140 controls the signal generator 130 to apply the initial reset signal to the image pickup 110. Accordingly, the light receiver 111 may empty the charge accumulated in each of the plurality of pixel regions in accordance with the initial reset signal generated by the signal generator 130, receives the exposure light for the image to be captured, and accumulates the charge for the received exposure light.

When an imaging command for one image is input, the controller 140 may determine the exposure patterns for the image to be captured in accordance with a predetermined condition. Here, the predetermined condition may be at least one among auto exposure (AE) information for receiving the exposure light in the plurality of pixel regions in relation to the image at a time when the imaging command is input, information on the lens 10 that receives the exposure light, and motion information that includes sensed values sensed by a motion sensor 180 to be described later.

For example, if the image to be captured is a scenery image, the controller 140 may determine a region having a large exposure amount and a region having a small exposure amount, through analyzing of the exposure amount that is received through the plurality of pixel regions, and may determine the corresponding exposure patterns. If the exposure pattern is determined in accordance with the predetermined condition as described above, the controller 140 may control the signal generator 130 to generate the reset signal for at least one of the plurality of pixel regions in accordance with the determined exposure pattern. In accordance with such a control command, the signal generator 130 may generate the reset signal for at least one of the plurality of pixel regions, and the controller 140 may control the signal generator 130 to apply the reset signal to the image pickup 110. Accordingly, at least one of the plurality of pixel regions may store the accumulated charge in the temporary storage 113 in accordance with the applied reset signal for at least one of the plurality of pixel regions.

Referring to FIG. 2, when the charge for one image is entirely stored in the temporary storage 113 through performing of the above-described series of operations, the image pickup 110 transfers the charge stored in the temporary storage 113 to a charge storage 115 in accordance with the control command of the controller 140, and transfers the charge stored in the charge storage 115 to the image processor 120. Accordingly, the image processor 120 receives the digital signal for the charge accumulated in relation to the one image, and performs image processing on the digital signal to generate an entire image signal for the captured image.

Referring again to FIG. 1, the controller 140 may determine the exposure patterns for the plurality of pixel regions, and apply the determined exposure patterns to the plurality of pixel regions.

In an exemplary embodiment, the controller 140 may apply a first exposure pattern to first pixel regions having a first brightness, and apply a second exposure pattern to second pixel regions having a second brightness, using brightness information of the plurality of pixel regions.

In another exemplary embodiment, the controller 140 may apply an exposure pattern of a short exposure type to pixel regions that are bright, and apply an exposure pattern of a long exposure type to pixel regions that are dark, using the brightness information for the plurality of pixel regions.

As described above, by applying the exposure patterns for exposure control of the plurality of pixel regions using the brightness information for the plurality of pixel regions, an image having a high dynamic range (HDR) can be acquired, and deterioration of resolution due to the image processing for acquiring the HDR image cm be minimized.

In still another exemplary embodiment, the controller 140 may apply the exposure pattern of the long exposure type to outer pixel regions, and apply the exposure pattern of the short exposure type to center pixel regions, among the plurality of pixel regions, in consideration of lens characteristics.

As described above, by performing the exposure control with respect to the plurality of pixel regions with the long exposure or short exposure type exposure pattern in consideration of the lens characteristics, a lens shading phenomenon that a luminance of a center portion and a luminance of a peripheral portion of the captured image become different from each other due to the characteristics of the lens 10, can be reduced.

In still another exemplary embodiment, the controller 140 may differently apply the exposure patterns in accordance with the degree of brightness of objects included in the one image. As described above, by differently applying the exposure patterns m accordance with the degree of brightness of the objects included in the one image, deterioration of resolution of the image of an object due to the imaging condition can he improved.

In still another exemplary embodiment, the controller 140 may apply an exposure pattern to perform an exposure in a time duration in which sensed values belong to a predetermined threshold range, among sensed values sensed by the motion sensor 180 while the one image is captured. As described above, by applying the exposure pattern on the basis of the sensed values sensed by the motion sensor 180, image blurring that occurs due to a user's hand trembling during imaging can be reduced.

Hereinafter, the image pickup 110 as described above will be described in more detail.

As illustrated in FIG. 2, each of the plurality of pixel regions that constitute the image pickup 110 includes the light receiver 111, the temporary storage 113, the charge storage 115, and a charge transferer 117. Further, each of the plurality of pixel regions includes a plurality of switches that perform a switching operation to transfer or intercept the transfer of the charge to the temporary storage 113, the charge storage 115, and the charge transferer 117 in relation to the charge accumulated in the plurality of pixel regions.

As described above, the light receiver 111 of each of the plurality of pixel regions receives the exposure light that is incident through the lens 10, converts the received exposure light into the electrical signal, and accumulates the charge that corresponds to the converted electrical signal. The image pickup 110 that is composed of the plurality of pixel regions may be, for example, a global shutter type image sensor, such as a CCD or CIS.

The temporary storage 113 temporarily stores the charge accumulated in the plurality of pixel regions. The single temporary storage 113 or a plurality of temporary storages of which a number corresponds to a number of the plurality of pixel regions, may be provided.

The charge storage 115 stores the charge accumulated in the temporary storage 113 in relation to one image, and the charge transferer 117 transfers the charge stored in the charge storage 115 to a side of the image processor 120 that performs image processing. Accordingly, the image processor 120 may perform image processing based on the charge or the digital signal that is converted through the ADC, to generate the entire image signal for the captured image.

As described above, if an imaging command for one image is input, the controller 140 controls the signal generator 130 to generate the initial reset signal. Accordingly, the signal generator 130 generates the initial reset signal, and the controller 140 controls the signal generator 130 to apply the initial reset signal to the image pickup 110. Accordingly, the image pickup 110 empties the charge accumulated in each of the plurality of pixel regions in accordance with the initial reset signal generated by the signal generator 130, receives the exposure light for the image to be captured, and accumulates the charge for the received exposure light.

Thereafter, the controller 140 determines the exposure pattern on the basis of the predetermined condition, and controls the signal generator 130 to generate a global reset signal for at least one of the plurality of pixel regions in accordance with the determined exposure pattern. As described above, the predetermined condition may be at least one of AE information for receiving the exposure light in the plurality of pixel regions in relation to the image at the time when the imaging command is input, information on the lens 10 that receives the exposure light, and motion information that includes sensed values sensed by the motion sensor 180 to be described later. For example, if the image to be captured is a scenery image, the controller 140 may determine a region having a large exposure amount and a region having a small exposure amount through analyzing of the exposure amount that is received through the plurality of pixel regions, determine the corresponding exposure patterns, and control the signal generator 130 to generate a reset signal for each of the regions in accordance with the determined exposure patterns.

The exposure pattern as described above includes at least one exposure time duration and at least one non-exposure time duration while the one image is captured. The exposure time duration may be a time duration in which a first switch 112 to be described later is turned on and the charge accumulated in the plurality of pixel regions is temporarily stored in the temporary storage 113 while the charge is accumulated through the plurality of pixel regions. Further, the non-exposure time duration is a time duration in which the reset signal for each of the regions is applied to the plurality of pixel regions after the first switch 112 is turned on, and the charge is not accumulated through the plurality of pixel regions.

In another example, the signal generator 130 generates the reset signal for each of the regions in accordance with the exposure patterns determined by the controller 140 to apply the generated reset signal to the image pickup 110. Accordingly, the plurality of pixel regions may receive time division multiple exposures in accordance with the applied reset signal for each of the regions.

In detail, after the initial reset signal that is generated through the signal generator 130 is applied to the image pickup 110, each of the plurality of pixels receives the exposure light that is incident through the lens 10 until the reset signal for each of the regions is applied to the image pickup 110, and accumulates the charge that corresponds to the converted electrical signal. While the charge is accumulated through the light receiver 111 of each of the plurality of pixels, the first switch 112 performs a switching-on operation. Accordingly, each of the plurality of pixels transfers the charge pre-accumulated in the light receiver 111 to the temporary storage 113, and the temporary storage 113 temporarily stores the charge accumulated in the plurality of pixel regions.

When the reset signal for each of the regions is applied through the signal generator 130 after the first switch 112 is turned on, the plurality of pixel regions interrupt reception of the exposure light that is incident through the lens 10 for a time that corresponds to the applied reset signal for each of the regions. Thereafter, when the time that corresponds to the applied reset signal for each of the regions elapses, the plurality of pixel regions receive the exposure light that is incident through the lens 10 until the reset signal for each of the regions is additionally applied through the signal generator 130 to the image pickup 110, accumulate the charge that corresponds to the converted electrical signal in relation to the received exposure light, and store the accumulated charge in the temporary storage 113 when the first switch 112 is turned on.

The above-described series of operations are repeatedly performed while one image is captured, and when the capturing of the one image is ended, a second switch 114 performs a switching-on operation. When the second switch 114 is turned on, the charge stored in the temporary storage 130 is transferred to the charge storage 115 to be finally stored in the charge storage 115. When the charge that is temporarily stored in the temporary storage 130 is stored in the charge storage 115, a third switch 116 performs a switching-on operation. Accordingly, the charge that is stored in the charge storage 115 is transferred to the charge transferer 117, and the charge transferer 117 outputs the charge that is transferred from the charge storage 115 to the side of the image processor 120.

Accordingly, the image processor 120 may receive the digital signal for the charge that is accumulated in relation to the one image, and perform image processing on the digital signal to generate an entire image signal for the captured image.

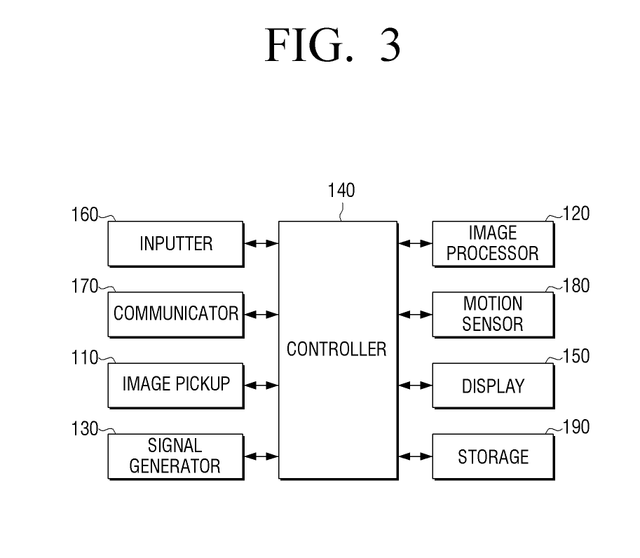

FIG. 3 is a detailed block diagram of the imaging apparatus of FIG. 1.

As illustrated in FIG. 3, the imaging apparatus further includes a display 150, an inputter 160, a communicator 170, the motion sensor 180, and a storage 190 in addition to the image pickup 110, the image processor 120, the signal generator 130, and the controller 140 as described above.

The display 150 displays at least one of image data processed by the image processor and OSD information on a screen in accordance with a control command of the controller 140. For example, the image data may be at least one of a captured image and a live-view image. The display 150 may be integrally implemented with a touch panel that receives an input of a user's touch command.

The inputter 160 receives an input of a user command, and may include, for example, at least one button. In another example, the inputter 160 may include a touch panel that is positioned on the display 150. Accordingly, the inputter 160 may receive a user command, such as, for example, an imaging command or an editing command for the captured image, from a user through at least one of the button and the touch panel.

The communicator 170 performs wireless or wired data communication with an external terminal device. To perform the wireless communication, the communicator 170 may include, for example, at least one of a Wi-Fi direct communication module, a Bluetooth module, an infrared data association (IrDA) module, a near field communication (NFC) module, a Zigbee module, a cellular communication module, a third generation (3G) mobile communication module, a fourth generation (4G) mobile communication module, and a fourth generation (4G) long term evolution (LTE) communication module.

To perform the wired communication, the communicator 170 may include, for example, an interface module, such as a USB, and may be physically connected to the external terminal device, such as a PC, through such an interface module. The communicator 170 may transmit and receive image data and firmware data for performing firmware upgrade to and from the external terminal device.

The motion sensor 180 senses motion of the imaging apparatus according to, e.g., a user's hand trembling, and outputs corresponding sensed values during capturing of one image. For example, the motion sensor 180 may be implemented by an acceleration sensor or a gyro sensor. Accordingly, if the sensed values sensed by the motion sensor 180 are output during the capturing of the one image as described above, the controller 140 may apply the exposure patterns to perform the exposure in a time duration in which the sensed values are in a predetermined threshold range, among the sensed values sensed by the motion sensor 180.

The storage 190 stores captured images and information that is used to control the imaging apparatus. For example, the storage 190 may be implemented by a storage medium, such as a volatile memory (e.g., a flash memory or an electrically erasable ROM (EEROM)) or a hard disk.

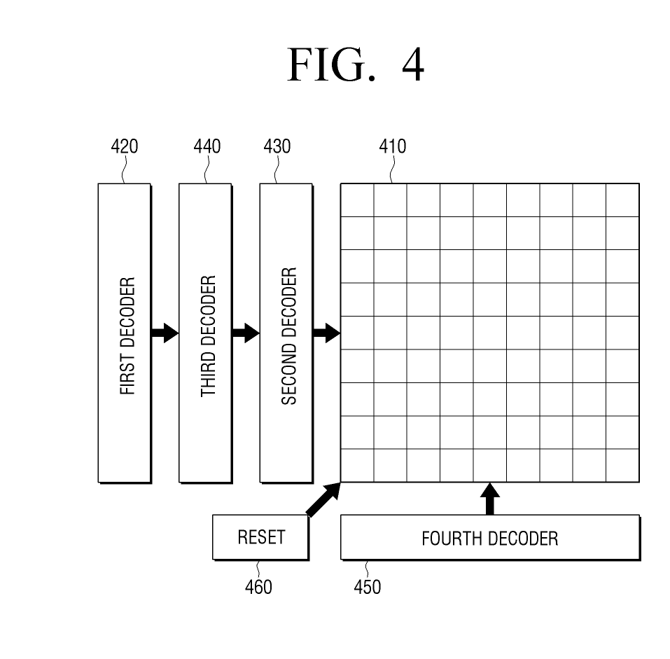

FIG. 4 is a diagram illustrating a structure of an image pickup according to an exemplary embodiment.

As illustrated in FIG. 4, a plurality of pixel regions that constitute the image pickup is formed in a pixel array 410 as a pattern arranged at predetermined intervals. When an initial reset signal is applied to the pixel array 410 through a first decoder 420, the plurality of pixel regions empty a charge remaining in the plurality of pixel regions, receive exposure light that is incident through a lens (e.g., the lens 10 of FIG. 2), convert the exposure light into an electrical signal, and then accumulate a charge that corresponds to the converted electrical signal.

When a switching control signal for a first switch (e.g., the first switch 112 of FIG. 2) is applied to the pixel array 410 through a second decoder 430 in a state where the charge is accumulated at the plurality of pixel regions, the first switch performs a switching-on operation. When the first switch is turned on, the plurality of pixel regions store the accumulated charge in a temporary storage (e.g., the temporary storage 113 of FIG. 2).

When a reset signal 460 for each of the regions is applied to the pixel array 410 after the first switch is turned on, the plurality of pixel regions do not receive the exposure light that is incident through the lens while the reset signal 460 for each of the regions is applied.

When the above-described series of operations are repeatedly performed and the charge for one image is entirely stored in the temporary storage, a third decoder 440 applies a switching control signal for a second switch (e.g., the second switch 114 of FIG. 2) to the pixel array 410. Accordingly, the second switch performs a switching-on operation, and a charge storage (e.g., the charge storage 115 of FIG. 2) stores the charge that is temporarily stored in the temporary storage.

Thereafter, when a switching control signal for a third switch (e.g., the third switch 116 of FIG. 2) is applied to the pixel array 410 through a fourth decoder 450, the charge that is stored in the charge storage is transferred to a charge transferer (e.g., the charge transfer 117 of FIG. 2), and the charge transferer outputs the charge that is received from the charge storage to a side of an image processor (e.g., the image processor 120 of FIG. 1).

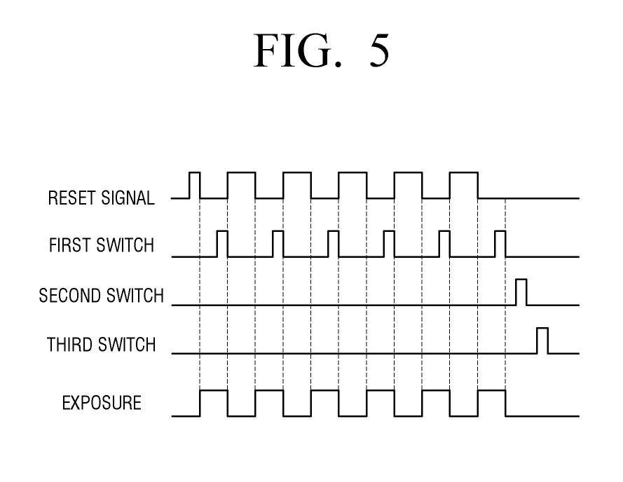

Hereinafter, referring to FIGS. 5 to 7, an operation of receiving exposure light so that an image pickup has different exposure amounts in accordance with exposure patterns will be described in detail.

FIG. 5 is a timing diagram illustrating short exposure type exposure patterns applied to a plurality of pixel regions that constitute an image pickup in accordance with a reset signal for each of the regions according to an exemplary embodiment.

As illustrated in FIG. 5, a short exposure type exposure pattern is for making an amount of exposure light (EXPOSURE) that is received in the plurality of pixel regions become smallest, and the signal generator 130 of FIG. 1 periodically applies, to the image pickup 110 of FIG. 1, a reset signal (RESET SIGNAL) for a first region that corresponds to the short exposure type exposure pattern, while one image is captured.

Accordingly, the plurality of pixel regions intercept the exposure light that is incident through the lens 10 of FIG. 2 when the reset signal for the first region is applied, receive the exposure light that is incident through the lens 10 when the reset signal for the first region is not applied, convert the received exposure light into an electric signal, and then accumulate a corresponding charge.

Before the reset signal for the first region that corresponds to the short exposure type exposure pattern is applied after an initial reset signal is applied to the image pickup 110, the first switch 112 (FIRST SWITCH) of FIG. 2 performs a switching-on operation. When the first switch 112 is switched on, the light receiver 111 of FIG. 2 of each of the plurality of pixels transfers the pre-accumulated charge to the temporary storage 113 of FIG. 2, and the temporary storage 113 temporarily stores the charge that is accumulated in the light receiver 111. When capturing of one image is ended through performing of the above-described series of operations, the second switch 114 (SECOND SWITCH) of FIG. 2 performs a switching-on operation, and when the second switch 114 is switched on, the charge storage 115 of FIG. 2 stores the charge that is temporarily stored in the temporary storage 113. When the charge that is temporarily stored in the temporary storage 113 is stored in the charge storage 115, the third switch 116 (THIRD SWITCH) of FIG. 2 performs a switching-on operation, and thus the charge transferer 117 of FIG. 2 outputs the charge that is stored in the charge storage 115 to a side of the image processor 120 of FIG. 1.

As described above, when the light receiver 111 receives the exposure light, in accordance with the reset signal for the first region that corresponds to the short exposure type exposure pattern, the image of the corresponding pixel region may be expressed as an image having low luminance.

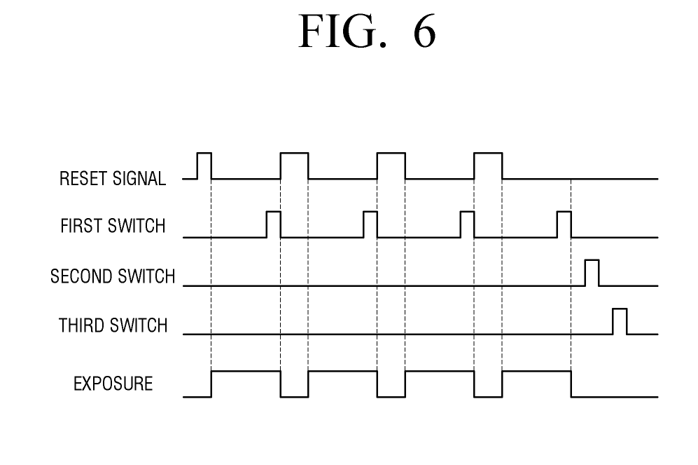

FIG. 6 is a timing diagram illustrating middle exposure type exposure patterns applied to a plurality of pixel regions that constitute an image pickup in accordance with a reset signal for each of the regions according to an exemplary embodiment.

As illustrated in FIG. 6, a middle exposure type exposure pattern is for making an amount of exposure light (EXPOSURE) that is received in the light receiver 111 of FIG. 2 become larger than an amount of exposure light of the short exposure type exposure pattern, and the signal generator 130 of FIG. 1 periodically applies, to the light receiver 111, a reset signal (RESET SIGNAL) for a second region that corresponds to the middle exposure type exposure pattern, while one image is captured. In this example, a number of applications of the reset signal for the second region that is applied to the light receiver 111 is smaller than a number of applications of the reset signal for the first region that corresponds to the short exposure type exposure pattern and is applied to the light receiver 111. Further, a length of the reset signal for the second region that is applied to the light receiver 111 may be shorter than a length of the reset signal for the first region that corresponds to the short exposure type exposure pattern and is applied to the light receiver 111.

In detail, the light receiver 111 intercepts the exposure light that is incident through the lens 10 of FIG. 2 when the reset signal for the second region is applied. In contrast, the hot receiver 111 receives the exposure light that is incident through the lens 10 when the reset signal for the second region is not applied, converts the received exposure light into an electric signal, and then accumulates the corresponding charge.

Before the reset signal for the second region that corresponds to the middle exposure type exposure pattern is applied after an initial reset signal is applied to the image pickup 110 of FIG. 1, the first switch 112 (FIRST SWITCH) of FIG. 2 performs a switching-on operation. When the first switch 112 is switched on, the light receiver 111 of each of the plurality of pixel regions transfers the pre-accumulated charge to the temporary storage 113, and the temporary storage 113 temporarily stores the charge that is accumulated in the light receiver 111. When capturing of one image is ended through performing of the above-described series of operations, the second switch 114 (SECOND SWITCH) of FIG. 2 performs a switching-on operation, and when the second switch 114 is switched on, the charge storage 115 of FIG. 2 stores the charge that is temporarily stored in the temporary storage 113. When the charge that is temporarily stored in the temporary storage 113 is stored in the charge storage 115, the third switch 116 (THIRD SWITCH) of FIG. 2 performs a switching-on operation, and thus the charge transferer 117 of FIG. 2 outputs the charge that is stored in the charge storage 115 to a side of the image processor 120 of FIG. 1.

As described above, when the light receiver 111 receives the exposure light in accordance with the reset signal for the second region that corresponds to the middle exposure type exposure pattern, the image of the corresponding pixel region may be expressed as an image having higher luminance than the luminance when the exposure light is received in accordance with the reset signal for the first region.

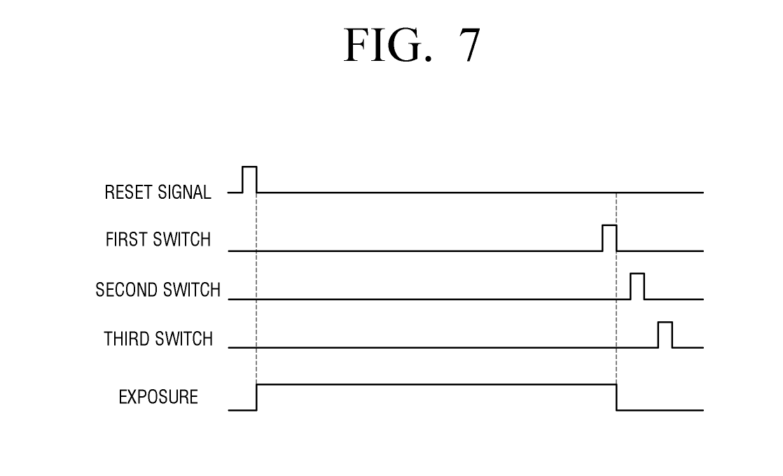

FIG. 7 is a timing diagram illustrating long exposure type exposure patterns applied to a plurality of pixel regions that constitute an image pickup in accordance with a reset signal for each of the regions according to an exemplary embodiment.

As illustrated in FIG. 7, a long exposure type exposure pattern is for making an amount of exposure light (EXPOSURE) that is received in the light receiver 111 of FIG. 2 becomes largest, and the signal generator 130 of FIG. 1 does not generate a reset signal for each of the regions that corresponds to the long exposure type exposure pattern.

Accordingly, the light receiver 111 of each of the plurality of pixel regions receives the exposure light that is incident through the lens 10 of FIG. 2 when capturing one image after an initial reset signal is applied to the light receiver 111, converts the received exposure light into an electric signal, and then accumulates the corresponding charge. Before the capturing of one image is ended, the first switch 112 (FIRST SWITCH) of FIG. 2 performs a switching-on operation. When the first switch 112 is switched on, the light receiver 111 transfers the pre-accumulated charge to the temporary storage 113 of FIG. 2, and the temporary storage 113 temporarily stores the charge that is accumulated in the plurality of pixel regions. Thereafter, the second switch 114 (SECOND SWITCH) of FIG. 2 performs a switching-on operation, and when the second switch 114 is switched on, the charge storage 115 of FIG. 2 stores the charge that is temporarily stored in the temporary storage 113. When the charge that is temporarily stored in the temporary storage 113 is stored in the charge storage 115, the third switch 116 (THIRD SWITCH) of FIG. 2 performs a switching-on operation, and thus the charge transferer 117 of FIG. 2 outputs the charge that is stored in the charge storage 115 to a side of the image processor 120 of FIG. 1.

As described above, when the light receiver 111 receives the exposure light in accordance with the long exposure type exposure pattern, the image of the corresponding pixel region may be expressed as an image having the highest luminance.

Up to now, the operation of receiving the exposure light so that the image pickup 110 has different exposure amounts in accordance with the reset signal for each of the regions according to the exposure patterns has been described in detail.

Hereinafter, an operation of performing an exposure control for the plurality of pixel regions that constitute the image pickup 110 in accordance with the exposure patterns that the above-described controller 140 determines from the plurality of pixel regions will be described in detail.

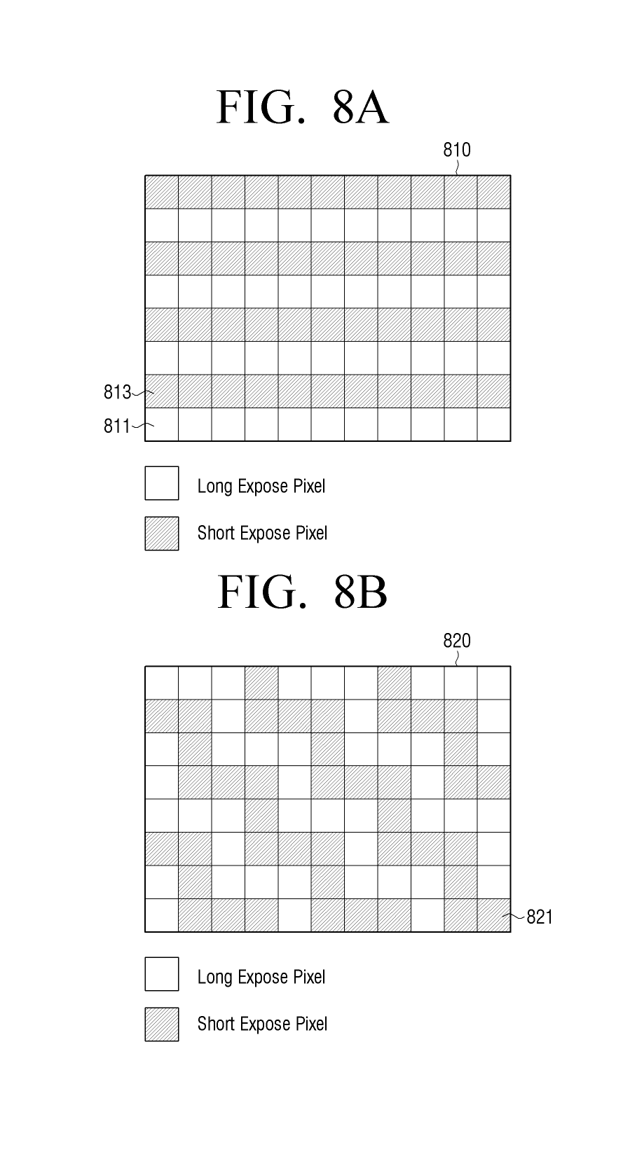

FIGS. 8A and 8B are first diagrams illustrating performing of an exposure control of a plurality of pixel regions that constitute an image pickup in accordance with exposure patterns according to an exemplary embodiment.

As illustrated in FIG. 8A, the controller 140 of FIG. 1 may apply a long exposure type exposure pattern or a short exposure type exposure pattern to the pixel regions arranged in a pixel array 810. In this example, the controller 140 applies the long exposure type exposure pattern to a first row 811 of the pixel array 810, and applies the short exposure type exposure pattern to a second row 813 of the pixel array 810.

In accordance with such a control command, as described above with reference to FIG. 5, the signal generator 130 of FIG. 1 generates a reset signal for a first region (the second row 813) that corresponds to the short exposure type exposure pattern, and applies the reset signal for the first region to the pixel regions that correspond to the second row 813. Accordingly, the pixel regions that correspond to the second row 813 intercept exposure light that is incident through a lens when the reset signal for the first region is applied, receive the exposure light that is incident through the lens 10 when the reset signal for the first region is not applied, convert the received exposure light into an electrical signal, and accumulate the corresponding charge. Thereafter, the pixel regions that correspond to the second row 813 temporarily store the charge accumulated in the respective pixel regions in accordance with a switching-on operation of a first switch.

On the other hand, the pixel regions that correspond to the first row 811 successively receive the exposure light that is incident through the lens when capturing one image after an initial reset signal is applied to the pixel regions. Thereafter, when a switching-on operation of a first switch starts before the capturing of the one image is ended, the pixel regions that correspond to the first row 811 temporarily store the charge accumulated in the respective pixel regions in a temporary storage.

Thereafter, as described above, the charge stored in the temporary storage is stored in a charge storage, and the charge stored in the charge storage is output to a side of the image processor 120 of FIG. 1 through a charge transferer. Accordingly, the image processor 120 receives a digital signal for the charge that is accumulated in relation to the one image, and performs image processing on the digital signal to generate an entire image signal for the captured image. Accordingly, as illustrated in FIG. 8A, an image of the pixel regions that correspond to the second row 813 (a dark image), and an image of the pixel regions that correspond to the first row 811 (a bright image), may be used to generate the corresponding entire image.

As illustrated in FIG. 8B, the controller 140 may apply a short exposure type exposure pattern or a long exposure type exposure pattern to the plurality of pixel regions arranged in the pixel array 820. In this example, the controller 140 applies the long exposure type exposure pattern to the pixel regions that correspond to coordinate values (1 ,1), (5,1), and (9,1) among the respective pixel regions of the first row 821 of the pixel array 810, and applies the short exposure type exposure pattern to remaining pixel regions among the respective pixel regions of the first row 821.

In accordance with the control command as described above, the signal generator 130 of FIG. 1 generates a reset signal for a first region that corresponds to the short exposure type exposure pattern, and applies the reset signal for the first region to the remaining pixel regions except for the pixel regions that correspond to the coordinate values (1,1), (5,1), and (9,1). Accordingly, the remaining pixel regions except for the pixel regions that correspond to the coordinate values (1,1), (5,1), and (9,1) intercept exposure light that is incident through a lens when the reset signal for the first region is applied, receive the exposure light that is incident through the lens when the reset signal for the first region is not applied, convert the received exposure light into an electrical signal, and accumulate the corresponding charge. Thereafter, the pixel regions temporarily store the charge accumulated in the corresponding pixel regions in a temporary storage in accordance with a switching-on operation of a first switch.

On the other hand, the pixel regions that correspond to the coordinate values (1,1), (5,1), and (9,1) successively receive the exposure light that is incident through the lens when capturing one image after an initial reset signal is applied to the pixel regions. Thereafter, when a switching-on operation of a first switch starts before the capturing of the one image is ended, the pixel regions that correspond to the coordinate values (1,1), (5,1), and (9,1) temporarily store the charge accumulated in the respective pixel regions in a temporary storage.

Thereafter, as described above, the charge stored in the temporary storage is stored in a charge storage, and the charge stored in the charge storage is output to a side of the image processor 120 of FIG. 1 through a charge transferer. Accordingly, the image processor 120 receives digital signal for the charge that is accumulated in relation to the one image, and performs imaging processing on the digital signal to generate an entire image signal for the captured image. Accordingly, as illustrated in FIG. 8B, the entire image, in which short exposure type pixel regions and long exposure type pixel regions among the plurality of pixel regions that constitute the one image are expressed to be uniformly distributed, may be generated.

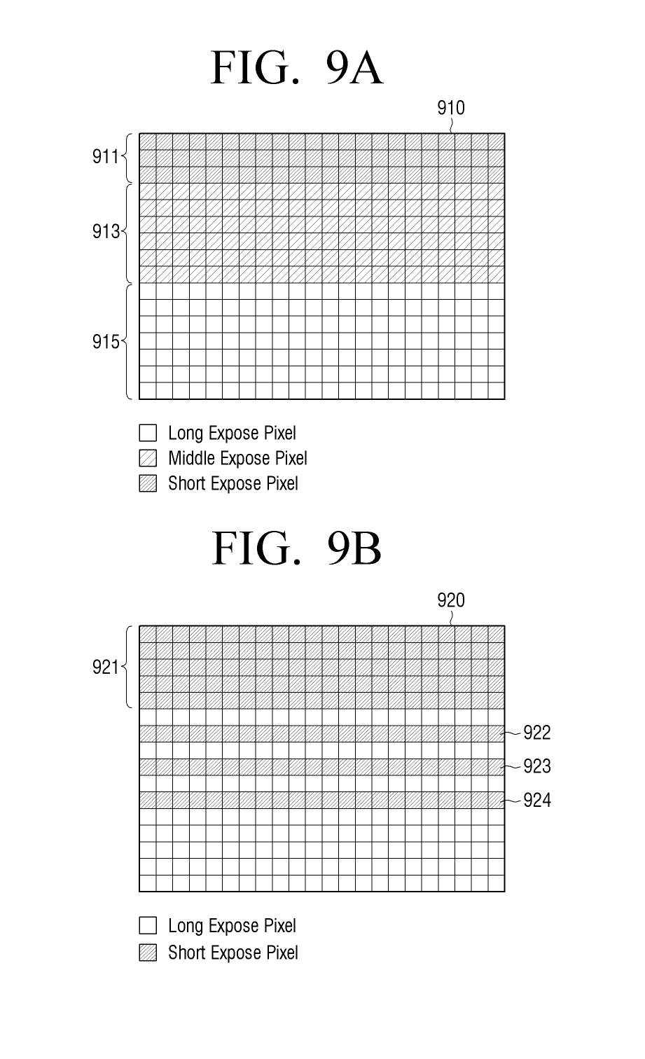

FIGS. 9A and 9B are second diagrams illustrating performing of an exposure control of a plurality of pixel regions that constitute an image pickup in accordance with exposure patterns according to another exemplary embodiment.

As illustrated in FIG. 9A, a controller 140 of FIG. 1 may apply different exposure patterns to the plurality of pixel regions arranged in a pixel array 910 based on AE information or data information on a live-view image.

In detail, the plurality of pixel regions may receive exposure light based on the AE information predetermined for the regions, and the controller 140 may determine degrees of brightness for the respective regions through analysis of images generated in accordance with the received exposure light in the plurality of pixel regions. For example, when an image to be captured is a scenery image, the pixel regions at an upper end of the pixel array 910 may receive the largest amount of exposure light. In this example, the controller 140 may determine the exposure patterns so that an exposure amount is increased in stages from the pixel regions at the upper end among the plurality of pixel regions that constitute the scenery image.

That is, as illustrated, the controller 140 applies a short exposure type exposure pattern to pixel regions that belong to a first section 911 among the pixel regions in the pixel array 910, applies a middle exposure type exposure pattern to pixel regions that belong to a second section 913, and applies a long exposure type exposure pattern to pixel regions that belong to a third section 915.

In accordance with such a control command, as described above with reference to FIGS. 5 and 6, the signal generator 130 of FIG. 1 generates a reset signal for a first region that corresponds to the short exposure type exposure pattern and a reset signal for a second region that corresponds to the middle exposure type exposure pattern, and applies the generated reset signals to the pixel regions that belong to the first and second sections 911 and 913, respectively.

The pixel regions of the first section 911 to which the reset signal for the first region is applied intercept the exposure light that is incident through a lens when the reset signal for the first region is applied, receive the exposure light that is incident through the lens when the reset signal for the first region is not applied, convert the received exposure light into an electrical signal, and accumulate the corresponding charge.

On the other hand, the pixel regions of the second section 913 to which the reset signal for the second region is applied intercept the exposure light that is incident through the lens when the reset signal for the second region is applied, receive the exposure light of which an amount is larger than an amount of exposure light received in the pixel regions of the first section 911, when the reset signal for the second region is not applied, convert the received exposure light into an electrical signal, and accumulate the corresponding charge.

Further, the pixel regions of the third section 915 successively receive the exposure light that is incident through the lens while one image is captured after an initial reset signal is applied to these pixel regions.

Thereafter, as described above, the charge stored in a temporary storage is stored in a charge storage, and the charge stored in the charge storage is output to a side of the image processor 120 of FIG. 1 through a charge transferer. Accordingly, the image processor 120 receives a digital signal for the charge that is accumulated in relation to the one image, and performs image processing on the digital signal to generate an entire image signal. Accordingly, as illustrated in FIG. 9A, an entire image, in which images of the plurality of pixel regions that constitute the one image are expressed to become brighter in stages, may be generated.

As illustrated in FIG. 9B, the plurality of pixel regions may receive the exposure light based on the AE information predetermined for the regions, and the controller 140 may determine degrees of brightness for the respective regions through analysis of images generated in accordance with the received exposure light in the plurality of pixel regions. For example, high luminance and lower luminance may be distributed in middle pixel regions among the plurality of pixel regions. In this example, the controller 140 may apply the short exposure type exposure pattern to the pixel regions having high luminance, and apply the long exposure type exposure pattern to the pixel regions having low luminance.

That is, as illustrated, the controller 140 applies the short exposure type exposure pattern to middle pixel regions that belong to rows 922 to 924 among the pixel regions arranged in a pixel array 920. In this example, the controller 140 applies the short exposure type exposure pattern to pixel regions that belong to a section 921 among the pixel regions, but exemplary embodiments are not limited thereto.

In accordance with such a control command, the signal generator 130 generates a reset signal for a first region that corresponds to the short exposure type exposure pattern, and applies the generated reset signal to the pixel regions that belong to the section 921 and to the rows 922 to 924.

Accordingly, the pixel regions to which the reset signal for the first region is applied intercept the exposure light that is incident through the lens when the reset signal for the first region is applied, receive the exposure light that is incident through the lens when the reset signal for the first region is not applied, convert the received exposure light into an electrical signal, and accumulate the corresponding charge.

On the other hand, remaining pixel regions to which the reset signal for the first region is not applied successively receive the exposure light that is incident through the lens while one image is captured after an initial reset signal is applied to these pixel regions.

Thereafter, as described above, the charge stored in a temporary storage is stored in a charge storage, and the charge stored in the charge storage is output to a side of the image processor 120 of FIG. 1 through a charge transferer. Accordingly, the image processor 120 receives the digital signal for the charge that is accumulated in relation to the one image, and performs image processing on the digital signal to generate an entire image signal for the captured image. Accordingly, as illustrated in FIG. 9B, an entire image, in which images of the plurality of pixel regions that constitute the one image are expressed to become brighter in stages, may be generated.

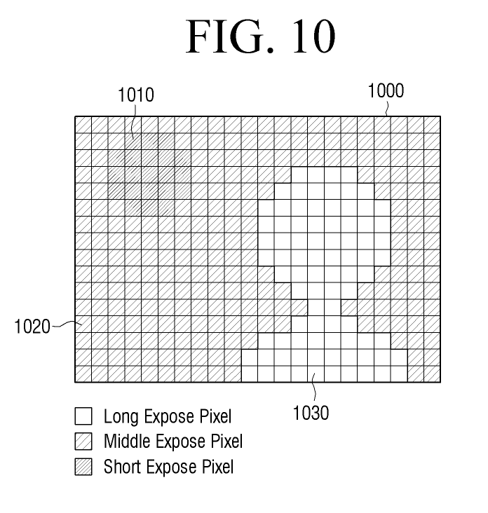

FIG. 10 is a third diagram illustrating performing of an exposure control of a light receiver in accordance with exposure patterns according to an exemplary embodiment.

As illustrated in FIG. 10, if live-view data for one image to be captured is input, the controller 140 of FIG. 1 analyzes a degree of brightness of the image through analysis of AE information and/or the live-view data. As illustrated, the image is composed of the sun, a person, and a background. In detail, first pixel regions 1010, in which the sun is positioned among a plurality of pixel regions that constitute the image pickup 110 of FIG. 1 and are arranged in a pixel array 1000, receive the largest amount of exposure light. Second pixel regions 1020 that represent the background among the plurality of pixel regions, receive the exposure light of which an amount is smaller than an amount of exposure light of the first pixel regions 1010. Further, third pixel regions 1030, in which the person is positioned among the plurality of pixel regions, receive the smallest amount of exposure light.

Accordingly, the controller 140 applies a short exposure type exposure pattern to the first pixel regions 1010, applies a middle exposure type exposure pattern to the second pixel regions 1020, and applies a long exposure type exposure pattern to the third pixel regions 1030.

However, exemplary embodiments are not limited thereto, and a storage may store a plurality of pieces of predetermined exposure pattern information. Accordingly, the controller 140 may apply exposure patterns that are related to brightness information of the plurality of pixel regions, among the plurality of pieces of predetermined exposure pattern information stored in the storage.

In this example, the controller 140 may select exposure patterns that are similar in shape to the first to third pixel regions 1010 to 1030, from the plurality of pieces of predetermined exposure pattern information stored in the storage 150, and apply the selected exposure patterns to the first to third pixel regions 1010 to 1030.

In accordance with such a control command, the signal generator 130 generates reset signals for first and second regions that correspond to the short exposure and middle exposure type exposure patterns, respectively, and applies the generated reset signals to the pixel array 1000. Accordingly, the first pixel regions 1010 intercept the exposure light that is incident through a lens when the reset signal for the first regions is applied, receive the exposure light that is incident through the lens when the reset signal for the first regions is not applied, convert the received exposure light into an electrical signal, and accumulate a corresponding charge.

On the other hand, the second pixel regions 1020 intercept the exposure light that is incident through the lens when the reset signal for the second regions is applied, receive the exposure light of which an amount is larger than an amount of exposure light of the first pixel regions 1010, when the reset signal for the second regions is not applied, convert the received exposure light into an electrical signal, and accumulate a corresponding charge.

Further, the third pixel regions 1030 successively receive the exposure light that is incident through the lens while one image is captured after an initial reset signal is applied to the pixel array 1000.

Thereafter, as described above, a charge stored in a temporary storage is stored in a charge storage, and the charge stored in the charge storage is output to a side of an image processor 120 of FIG. 1 through a charge transferer. Accordingly, the image processor 120 receives digital signal for the charge that is accumulated in relation to the one image, and perform image processing on the digital signal to generate an entire image signal for the captured image. Accordingly, a backlight phenomenon that an object that is included in one image appears dark due to another object can be reduced.

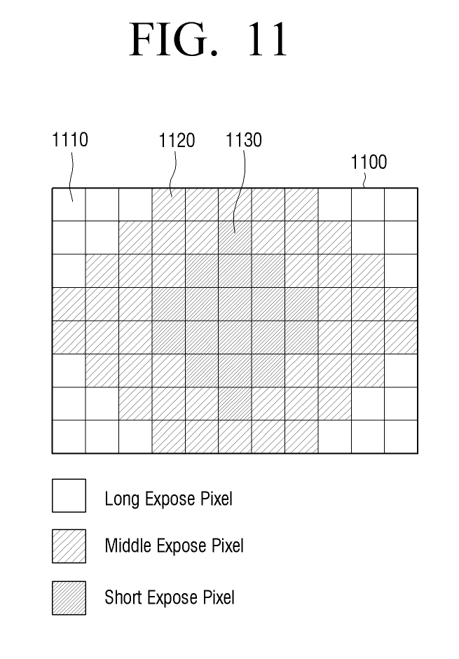

FIG. 11 is a fourth diagram illustrating performing of an exposure control of a light receiver in accordance with exposure patterns according to another exemplary embodiment.

As illustrated in FIG. 11, the controller 140 of FIG. 1 may apply different exposure patterns to a plurality of pixel regions that constitute an image pickup 110 of FIG. 1 and are arranged in a pixel array 1100 in consideration of characteristics of a lens.

In detail, in a compact digital camera or a camera that is built in a mobile terminal device, a lens having a very small size may need to be used. Due to the small lens, a lens shading phenomenon that characteristics of a center region and a peripheral region of the lens become different from each other, may occur. Due to such a lens shading phenomenon, luminance of an image in a peripheral pixel region of a captured image may be deteriorated in comparison to luminance of an image of a center pixel region of the captured image.

Accordingly, the controller 140 applies exposure patterns in stages from a first pixel region 1130 that corresponds to a center region among the plurality of pixel regions in consideration of the characteristics of the lens. That is, the controller 140 applies a short exposure type exposure pattern to the first pixel regions 1130 that correspond to the center region among the plurality of pixel regions, applies a middle exposure type exposure pattern to second pixel regions 1120 that correspond to a middle region among the plurality of pixel regions, and applies a long exposure type exposure pattern to third pixel regions 1130 that correspond to a peripheral region among the plurality of pixel regions.

In accordance with such a control command, the signal generator 130 generates a reset signal for first regions for applying the short exposure type exposure pattern to the first pixel regions 1130, generates a reset signal for second regions for applying the middle exposure type exposure pattern to the second pixel regions 1120, and applies the generated reset signals to the pixel array 1100.

Accordingly, the first pixel regions 1120 intercept exposure light that is incident through the lens when the reset signal for the first regions is applied, receive the exposure light that is incident through the lens when the reset signal for the first regions is not applied, convert the received exposure light into an electrical signal, and accumulate a corresponding charge.

On the other hand, the second pixel regions 1130 intercept the exposure light that is incident though the lens when the reset signal for the second regions is applied, receive the exposure light of which an amount is larger than an amount of exposure light of the first pixel regions 1120 when the reset signal for the second regions is not applied, convert the received exposure light into an electrical signal, and accumulate a corresponding charge.

Further, the third pixel regions 1110 successively receive the exposure light that is incident through the lens while one image is captured after an initial reset signal is applied to the pixel array 1100.

Thereafter, as described above, the charge stored in a temporary storage is stored in a charge storage, and the charge stored in the charge storage is output to a side of the image processor 120 of FIG. 1 through a charge transferer. Accordingly, the image processor 120 receives a digital signal for the charge that is accumulated in relation to the one image, and performs an image processing on the digital signal to generate an entire image signal for the captured image. Accordingly, the lens shading phenomenon that luminance of an outline of the captured image is deteriorated can be reduced.

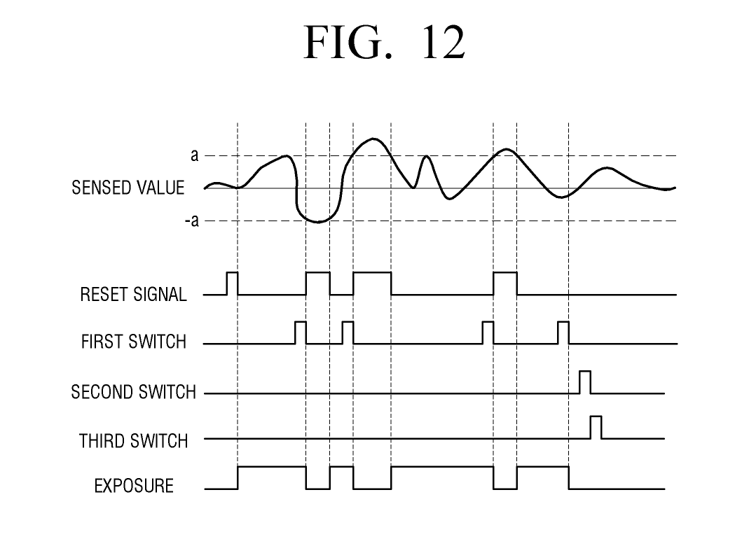

FIG. 12 is a fifth diagram illustrating performing of an exposure control of a light receiver in accordance with exposure patterns according to still another exemplary embodiment.

As illustrated in FIG. 12, the controller 140 of FIG. 1 may apply exposure patterns to perform exposure in a plurality of pixel regions that constitute the image pickup 110 of FIG. 1 in a time duration in which sensed values that belong to a predetermined threshold range, among sensed values sensed by the motion sensor 180 of FIG. 3, are sensed while one image is captured.

In detail, the motion sensor 180 periodically determines sensed values according to a motion of the imaging apparatus while an image that corresponds to an imaging command that is input from a user is captured. When the sensed values are determined, the controller 140 determines whether the calculated sensed values belong to a predetermined threshold range of a through −a. The controller 140 applies an exposure pattern to the plurality of pixel regions by controlling the signal generator 130 of FIG. 1 to apply a reset signal for each of the regions in a time duration in which the sensed values are outside the predetermined threshold range. For example, the time duration in which the sensed values are outside the predetermined threshold range may be when hand trembling occurs during the image capturing.

In accordance with such a control command, the signal generator 130 generates the reset signal for each of the regions for the exposure control of the plurality of pixel regions, and applies the generated reset signal to the respective pixel regions. Accordingly, the plurality of pixel regions intercept exposure light that is incident through a lens when the reset signal for each of the regions is applied, receive the exposure light that is incident through the lens when the reset signal for each of the regions is not applied, and accumulate a corresponding charge. That is, the plurality of pixel regions may receive the exposure light that is incident from the lens in a time duration in which the hand trembling does not occur, and intercept the exposure light that is incident from the lens in the time duration in which the hand trembling occurs.

As described above, because the image pickup 110 intercepts the exposure light in the time duration in which the hand trembling occurs in accordance with the reset signal for each of the regions, a motion artifact phenomenon that occurs on the capture image can be reduced.

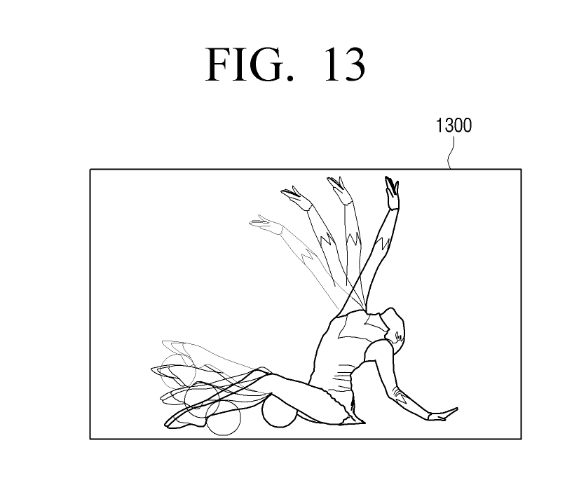

FIG. 13 is a diagram illustrating a multi-exposure image in accordance with an exposure control of a plurality of pixel regions that constitute an image pickup in accordance with exposure patterns according to an exemplary embodiment.

As illustrated in FIG. 13, to generate a multi-exposure image in a multi-exposure method, the controller 140 of FIG. 1 may apply an exposure pattern for receiving the same time division exposure light through entire pixel regions that constitute the image pickup 110 of FIG. 1. The multi-exposure image may be an image in which a plurality of images successively appears through successive reception of the exposure light on one image to be captured.

In accordance with a control command for the exposure pattern according to the multi-exposure method, the signal generator 130 of FIG. 1 may successively generate a reset signal for each of the regions that corresponds to the exposure pattern, and apply the reset signal for each of the regions to the plurality of pixel regions. Accordingly, the plurality of pixel regions can successively receive the same reset signal for each of the regions.

In an exemplary embodiment, as described above with reference to FIG. 4, the signal generator 130 may generate the reset signal for each of the regions that correspond to the short exposure type exposure pattern, and apply the generated reset signal to the plurality of pixel regions. Accordingly, the plurality of pixel regions may intercept the exposure light that is incident through a lens when the same reset signal for each of the regions is applied, and receive the exposure light that is incident through the lens when the reset signal for each of the regions is not applied. When a charge for the one image is entirely stored in a temporary storage through performing of the above-described series of operations, the charge that is temporarily stored in the temporary storage may be stored in a charge storage, and the charge that is stored in the charge storage may be transferred to the image processor 120 of FIG. 1 through a charge transferer.

Accordingly, the image processor 120 may receive a digital signal for the charge accumulated in relation to the one image, and generate an entire image signal for the captured image through performing of image processing, such as correction and synthesis, on the digital signal. Thereafter, to successively generate a plurality of images on the generated image, the signal generator 130 may apply the reset signal for each of the regions for the exposure pattern according to the multi-exposure method to the image pickup 110. That is, the signal generator 130 may apply the reset signal for each of the regions to the image pickup 110 as many times as a number of images.

Accordingly, the respective pixel regions that constitute the pre-generated entire image may successively perform reception and interception of the exposure light through the lens in accordance with the reset signal for each of the successive regions, and thus, as illustrated, a multi-exposure image 1300 for the pre-generated image can be generated.

Up to now, the operation of the imaging apparatus to control the exposure light of each of the plurality of pixel regions that constitute the image pickup 110 based on the reset signal for each of the regions that is generated in accordance with the exposure pattern has been described in detail. Hereinafter, an imaging method of an imaging apparatus to control exposure light of each of a plurality of pixel regions that constitute an image pickup 110 will be described in detail.

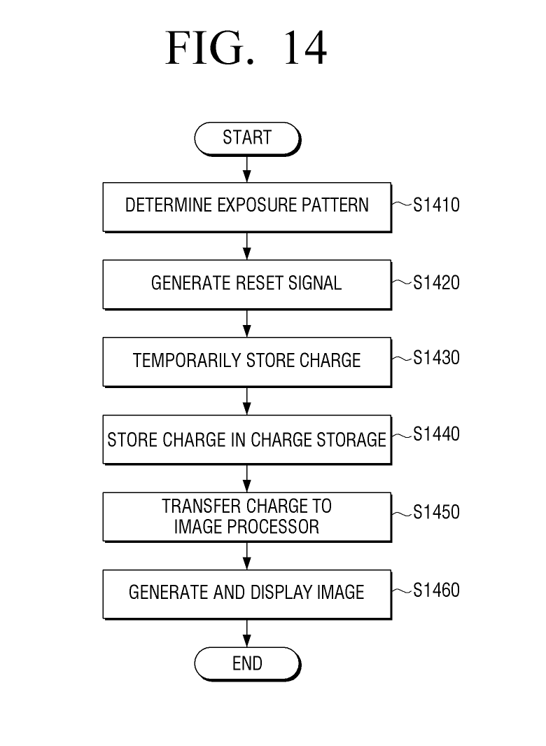

FIG. 14 is a flowchart of an imaging method of an imaging apparatus according to an exemplary embodiment.

As illustrated in FIG. 14, the imaging apparatus determines an exposure pattern for one image to be captured (S1410). Thereafter, the imaging apparatus generates a reset signal in accordance with the determined exposure pattern, and temporarily stores charge that is accumulated in a light receiver of each of a plurality of pixel regions that constitute an image pickup in accordance with the generated reset signal (S1420 and S1430). In detail, when the reset signal is applied to each of the plurality of pixel regions, the imaging apparatus stores the charge accumulated in the light receiver of each of the plurality of pixel regions in a temporary storage through turning-on a first switch.

In more detail, when an imaging command for one image is input, the imaging, apparatus generates an initial reset signal, and applies the generated initial reset signal to the image pickup. The plurality of pixel regions empty charge that is accumulated in the light receiver for each of the plurality of pixel regions in accordance with the applied initial reset signal, receive the exposure light for the image to be captured, and accumulate the charge for the received exposure light. For example, the image pickup may be a global shutter type image sensor, such as a CCD or CIS.

When the charge is accumulated through the plurality of pixel regions, the imaging apparatus generates, and applies to the image pickup, the reset signal for each of the regions for receiving and intercepting the exposure light in at least one of the plurality of pixel regions in accordance with the determined exposure pattern. Accordingly, after the reset signal for each of the regions is applied, at least one of the plurality of pixel regions performs a first switching-on operation to store in a temporary storage the charge pre-accumulated in the light receiver.

The exposure pattern for generating the reset signal for each of the regions as described above may include at least one exposure time duration and at least one non-exposure time duration while the one image is captured. The exposure time duration is a time duration in which the first switch is turned on and the charge accumulated in the light receiver of each of the plurality of pixel regions is temporarily stored in the temporary storage ehile the charge is accumulated through the plurality of pixel regions. Further, the non-exposure time duration is a time duration in which the reset signal for each of the regions is applied to the plurality of pixel regions and the charge is not accumulated in the temporary storage after the first switch is turned on.

In other exemplary embodiments, the imaging apparatus may determine exposure patterns for the plurality of pixel regions that constitute the one image, and apply the determined exposure patterns to the plurality of pixel regions.

In an exemplary embodiment, the imaging apparatus may apply a first exposure pattern to first pixel regions having a first brightness, and apply a second exposure pattern to second pixel regions having a second brightness, using brightness information of the plurality of pixel regions.

In another exemplary embodiment, the imaging apparatus may apply an exposure pattern of a short exposure type to pixel regions that are bright, and apply an exposure pattern of a long exposure type to the pixel regions that are dark, using the brightness information for the plurality of pixel regions. As described above, by applying the exposure patterns for exposure control of the plurality of pixel regions using the brightness information for the plurality of pixel regions, an image having an HDR can be acquired, and a loss of image information due to image processing for acquiring the HDR image can be minimized.

In still another exemplary embodiment, the imaging apparatus may acquire exposure pattern information that is related to the brightness information of the plurality of pixel regions among a plurality of pieces of pre-stored exposure pattern information and perform exposure control of the plurality of pixel regions based on the acquired exposure pattern information.

In still another exemplary embodiment, the imaging apparatus may apply the exposure pattern of the long exposure type to outer pixel regions, and apply the exposure pattern of the short exposure type to center pixel regions, among the plurality of pixel regions, in consideration of lens characteristics. As described above, by performing the exposure control of the plurality of pixel regions with the long exposure and short exposure type exposure patterns in consideration of the lens characteristics, a lens shading phenomenon that luminance of a center portion and luminance of a peripheral portion of the captured image become different from each other due to the characteristics of the lens, can be reduced.

In still another exemplary embodiment, the imaging apparatus may differently apply exposure patterns in accordance with a degree of brightness of each object included in one image. As described above, by differently applying the exposure patterns based on each object included in the one image, a loss of image information of an object in accordance with an imaging condition can be reduced.

In still another exemplary embodiment, the imaging apparatus may apply an exposure pattern to perform an exposure in a time duration in which sensed values that belong to a predetermined threshold range are sensed, among sensed values sensed by a motion sensor that senses motion, such as hand trembling, while the one image is captured. As described above, by applying the exposure pattern based on the sensed values sensed by the motion sensor 180, the imaging apparatus can improve image blurring that occurs due to the user's hand trembling during the imaging.

Accordingly, through the various exemplary embodiments described above, the image apparatus may determine the exposure pattern for the image to be captured, and generate and apply to the image pickup the reset signal for each of the plurality of pixel regions in accordance with the determined exposure pattern.

If the first switch is turned on after the reset signal for each of the plurality of pixel regions is applied, the charge accumulated in the light receiver of each of the plurality of pixel regions is temporarily stored in the temporary storage, and the imaging apparatus stores in a charge storage the charge that is temporarily stored in the temporary storage through turning-on of a second switch (S1440). Thereafter, the imaging apparatus transfers the charge stored in the charge storage to an image processor that processes the image to be captured, through turning-on of a third switch (S1450). Accordingly, the imaging apparatus generates and displays the image that is processed through the image processor (S1460).

In addition, the exemplary embodiments may also be implemented through computer-readable code and/or instructions on a medium, e.g., a non-transitory computer-readable medium, to control at least one processing element to implement any above-described embodiments. The medium may correspond to any medium or media which may serve as a storage and/or perform transmission of the computer-readable code.

The computer-readable code may be recorded and/or transferred on a medium in a variety of ways, and examples of the medium include recording media, such as magnetic storage media (e.g., ROM, floppy disks, hard disks, etc.) and optical recording media (e.g., compact disc read only memories (CD-ROMs) or digital versatile discs (DVDs)), and transmission media such as Internet transmission media. Thus, the medium may have a structure suitable for storing or carrying a signal or information, such as a device carrying a bitstream according to one or more exemplary embodiments. The medium may also be on a distributed network, so that the computer-readable code is stored and/or transferred on the medium and executed in a distributed fashion. Furthermore, the processing element may include a processor or a computer processor, and the processing element may be distributed and/or included in a single device.

The foregoing exemplary embodiments and advantages are merely exemplary embodiments and are not to be construed as limiting the exemplary embodiments. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. An imaging apparatus comprising:
an image pickup comprising a pixel, the pixel being configured to accumulate a charge;
an image processor configured to perform image processing based on the accumulated charge to generate an image;
a signal generator; and
a controller configured to
determine an exposure pattern of the pixel, and
control the signal generator to generate a reset signal based on the determined exposure pattern,
wherein the pixel is configured to accumulate the charge based on the reset signal.

2. The imaging apparatus as claimed in claim 1, wherein the pixel comprises:
a light receiver;
a temporary storage configured to temporarily store the charge that is accumulated in the light receiver;
a charge storage configured to store the charge temporarily stored in the temporary storage;
a charge transferer configured to transfer the charge stored in the charge storage to the image processor;
a first switch configured to turn on to temporarily store in the temporary storage the charge accumulated in the light receiver after the signal generator generates and applies to the pixel an initial reset signal;
a second switch configured to turn on to store in the charge storage the charge temporarily stored in the temporary storage; and
a third switch configured to turn on to transfer the charge stored in the charge storage to the charge transferer.

3. The imaging apparatus as claimed in claim 2, wherein the exposure pattern comprises an exposure time duration and a non-exposure time duration,
the exposure time duration is a time duration in which the charge is accumulated in the light receiver after the signal generator applies the initial reset signal to the pixel, and the first switch is turned on to temporarily store in the temporary storage the charge accumulated in the light receiver, and
the non-exposure time duration is a time duration in which the signal generator applies the reset signal to the pixel to suspend the charge from accumulating in the light receiver after the first switch is turned on.

4. The imaging apparatus as claimed in claim 1, wherein the controller is further configured to determine exposure patterns of pixels that constitute the image.

5. The imaging apparatus as claimed in claim 4, wherein the controller is configured to apply a first exposure pattern to first pixels having a first brightness, among the pixels, and apply a second exposure pattern to second pixels having a second brightness, among the pixels, based on brightness information of the pixels.

6. The imaging apparatus as claimed in claim 5, wherein the controller is configured to apply an exposure pattern of a short exposure type to pixels that are bright, among the pixels, and apply an exposure pattern of a long exposure type to pixels that are dark, among the pixels, based on the brightness information.

7. The imaging apparatus as claimed in claim 4, wherein the controller is configured to apply an exposure pattern of a long exposure type to outer pixels, among the pixels, and apply an exposure pattern of a short exposure type to center pixels, among the pixels, based on lens characteristics.

8. The imaging apparatus as claimed in claim 4, wherein the controller is configured to differently apply the exposure patterns to respective objects included in the image.

9. The imaging apparatus as claimed in claim 4, further comprising a motion sensor configured to sense motion of the imaging apparatus,
wherein the controller is configured to apply, to at least one of the pixels, an exposure pattern to perform exposure in a time duration in which the sensed motion belongs to a range.

10. The imaging apparatus as claimed in claim 4, further comprising a storage configured to store the exposure patterns,
wherein the controller is configured to apply the stored exposure patterns to the pixels based on brightness information of the pixels.

11. The imaging apparatus as claimed in claim 1, wherein the image pickup is a global shutter type image sensor.

12. An imaging method of an imaging apparatus comprising:
determining an exposure pattern of a pixel;
generating a reset signal based on the determined exposure pattern;
accumulating charge in the pixel based on the reset signal; and
performing image processing based on the accumulated charge to generate an image.

13. The imaging method as claimed in claim 12, wherein the accumulating comprises:
temporarily storing in a temporary storage the charge that is accumulated in a light receiver by turning on a first switch after generating and applying to the pixel an initial reset signal;
storing in a charge storage the charge temporarily stored in the temporary storage by turning on a second switch; and
transferring the charge stored in the charge storage to an image processor that performs the image processing by turning on a third switch.

14. The imaging method as claimed in claim 13, wherein the exposure pattern comprises an exposure time duration and a non-exposure time duration,
the exposure time duration is a time duration in which the charge is accumulated in the light receiver after the signal generator applies the initial reset signal to the pixel, and the first switch is turned on to temporarily store in the temporary storage the charge accumulated in the light receiver, and
the non-exposure time duration is a time duration in which the signal generator applies the reset signal to the pixel to suspend the charge from accumulating in the light receiver after the first switch is turned on.

15. The imaging method as claimed in claim 12, further comprising determining exposure patterns of pixels that constitute the image.

16. The imaging method as claimed in claim 15, wherein the determining the exposure patterns comprises applying a first exposure pattern to first pixels having a first brightness, among the pixels, and applying a second exposure pattern to second pixels having a second brightness, among the pixels, based on brightness information of the pixels.

17. The imaging method as claimed in claim 16, wherein the determining the exposure patterns comprises applying an exposure pattern of a short exposure type to pixels that are bright, among the pixels, and applying an exposure pattern of a long exposure type to pixels that are dark, among the pixels, based on the brightness information.

18. The imaging method as claimed in claim 15, wherein the determining the exposure patterns comprises applying an exposure pattern of a long exposure type to outer pixels, among the pixels, and applying an exposure pattern of a short exposure type to center pixels, among the pixels, based on lens characteristics.

19. The imaging method as claimed in claim 15, wherein the determining the exposure patterns comprises differently applying the exposure patterns to respective objects included in the image.

20. The imaging method as claimed in claim 15, further comprising sensing motion of the imaging apparatus,
wherein the determining the exposure patterns comprises applying, to at least one of the pixels, an exposure pattern to perform exposure in a time duration in which the sensed motion belongs to a range.

21. The imaging method as claimed in claim 15, further comprising storing the exposure patterns,
wherein the determining the exposure patterns comprises applying the stored exposure patterns to the pixels based on brightness information of the pixels.

22. The imaging method as claimed in claim 15, wherein the pixels are included in a global shutter type image sensor.

23. An imaging apparatus comprising:
an image pickup comprising pixels;
a controller configured to control a light exposure of the pixels based on at least one among brightness information of the pixels, lens information of the pixels, and motion of the imaging apparatus; and
an image processor configured to perform image processing based on a charge that is accumulated in each of the pixels to generate an image.

24. The imaging apparatus of claim 23, wherein the controller is configured to:
apply a long light exposure to dark pixels, among the pixels; and
apply a short light exposure to bright pixels, among the pixels.

25. The imaging apparatus of claim 23, wherein the controller is configured to:
apply a long light exposure to outer pixels corresponding to an outer region of a lens of the imaging apparatus, among the pixels; and
apply a short light exposure to center pixels corresponding to a center region of the lens, among the pixels.

26. The imaging apparatus of claim 23, wherein the controller is configured to apply, to at least one of the pixels, a light exposure of a time duration in which the motion is in a range.
